(19) United States
(12) Patent Application Publication
(10) Pub. No.: US 2026/0267719 A1
(43) Pub. Date: Sep. 10, 2026

(54) SYSTEMS AND METHODS FOR ACCOUNT SCHEMATIC ARCHITECTURES

(71) Applicant: JPMORGAN CHASE BANK, N.A., New York, NY (US)

(72) Inventors: Jesse SCHWIMMER, Brooklyn, NY (US); Michele CHEN, Manhattan, NY (US); Hariharan SIVARAJ, Edison, NJ (US); Srinivasa KAPIDI, Flemington, NJ (US); Maneesh SUBHERWAL, Jersey City, NJ (US); Leslie HAMILTON, New York, NY (US); Chris STABILE, New York, NY (US); Devender RAMASAHAYAM, Belle Mead, NJ (US); Madhukar KUNTAMUKKALA, Monroe, NJ (US); Issa OUEDRAOGO, Newark, NJ (US)

(21) Appl. No.: 19/072,384

(22) Filed: Mar. 6, 2025

(51) Int. Cl. G06F 9/54

(52) U.S. Cl. CPC G06F 9/546; G06F 9/547

(57) ABSTRACT

In some embodiments, the techniques described herein relate to a method including: receiving, through an event bridge application executed by a processor, a scheduled invocation; calling, by a data feed task, an application programming interface (“API”) from a datacenter, the API call including a parameter used by the datacenter to retrieve a data file according to the parameter, the parameter including a name or identifier; receiving, by the data feed task, the data file; receiving, by the event bridge application and from the cloud database, a notification based on the data file; publishing, by a data publish task, one or more messages based on the notification to a topic; pushing, by the data publish task, the one or more messages to a queue; consuming, by a listener, the message from the queue based on detecting the queue receiving the message; and inserting, by the listener, the message in a database.

### BACKGROUND

### 1. Field of The Invention

Aspects generally relate to systems and methods for account schematic architectures.

### 2. Description of the Related Art

Account schematics for particular institutions are difficult to create because of the multiple and diverse data sources that must be accessed and combined in addition to the challenge of severely fragmented data. Current efforts to create such schematics can be cumbersome and take significant manual labor and time (weeks and months in some cases). Account schematics produced by current systems are also not comprehensive and are not customizable. Account schematics produced by current systems are specific to only certain use cases. Further, individual schematics produced create individual views leveraging singular slices of defined data sets but not a comprehensive view of the institution leveraging multiple slides and data sets. This is because data for the schematics are fragmented across multiple sources, each with a limited and incomplete scope of the institution. Many users create the data with many different systems, creating the fragmented sources. There is thus a lack of centralized, aggregated data that contributes to the failure to create comprehensive schematics of the institution. Because of failures of current systems, it is desired to create an account schematic architecture capable of creating a comprehensive view of an institution efficiently, automatically, and without significant gaps in coverage, also capable of flexible and multi-layered data visualizations.

### SUMMARY

Exemplary embodiments provide systems and methods for generating a merchant trust score. According to one embodiment, a method may include receiving, through an event bridge application executed by one or more processors, a scheduled invocation; calling, by a data feed task executed by the one or more processors, an application programming interface (“API”) from a datacenter, the API call including a parameter used by the datacenter to retrieve one or more data files according to the parameter, the parameter including a name or identifier; receiving, by the data feed task, the one or more data files; uploading by the data feed task, the one or more data files to a cloud database; receiving, by the event bridge application and from the cloud database, a notification based on the one or more data files; invoking, by the event bridge application, a data publish task executed by the one or more processors; publishing, by the data publish task, one or more messages based on an attribute name value pair of each parameter to a topic; pushing, by the data publish task, the one or more messages to a queue determined based on the topic; consuming, by a listener executed by the one or more processors and configured to communicate with a database of a consumer device, the one or more messages from the queue based on detecting the queue receiving the one or more message; and inserting, by the listener, the one or more messages in the database of the consumer device.

In some embodiments, the datacenter may retrieve the parameter using an individual data feed URL using an environment variable override. In some embodiments, the individual data feed URL may be a source system based on a URL communication protocol. In some embodiments, the queue may include a filter policy. In some embodiments, the listener may initiate when a message is received in the queue. In some embodiments, the listener may initiate when an insert, update, or deletion of the message in the queue. In some embodiments, the data publish task may use a batch feature to publish multiple messages of the one more messages at a time to the topic.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for an account schematic architecture, in accordance with embodiments.

FIG. 2 is a method for account schematic architectures, in accordance with embodiments.

FIG. 3 is a block diagram of a computing device for implementing certain aspects of the present disclosure.

### DETAILED DESCRIPTION

Aspects generally relate to systems and methods for account schematic architectures.

Disclosed are systems and methods including receiving, through an event bridge application executed by one or more processors, a scheduled invocation; calling, by a data feed task, an application programming interface (“API”) from a datacenter, the API call including a parameter used by the datacenter to retrieve one or more data files according to the parameter, the parameter including a name or identifier; receiving, by the data feed task, the one or more data files; uploading by the data feed task, the one or more data files to a cloud database; receiving, by the event bridge application and from the cloud database, a notification based on the one or more data files; invoking, by the event bridge application, a data publish task; publishing, by the data publish task, one or more messages based on the notification to a topic; pushing, by the data publish task, the one or more messages to a queue; consuming, by a listener, the one or more messages from the queue based on detecting the queue receiving the one or more message; and inserting, by the listener, the one or more messages in a database.

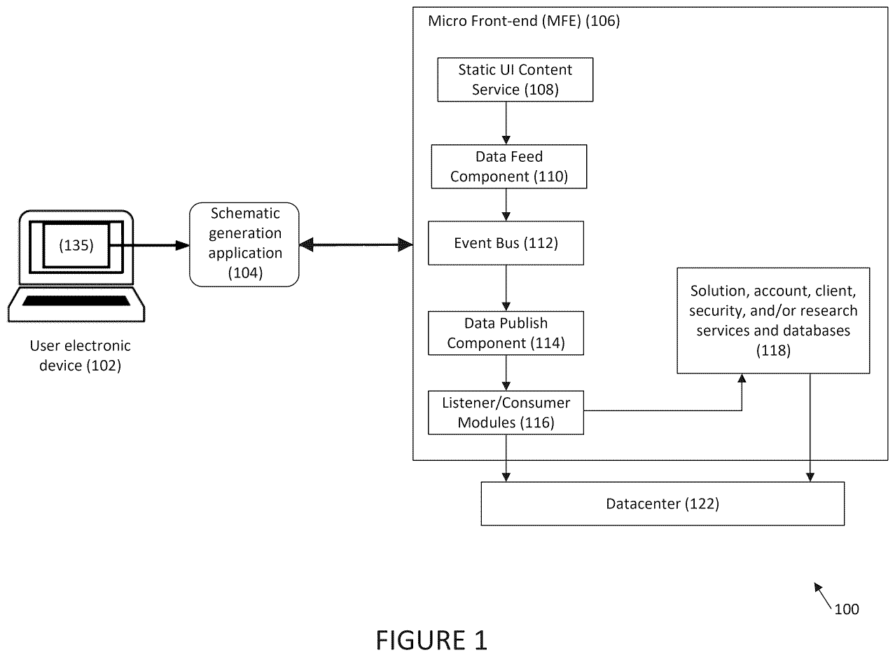

FIG. 1 is a block diagram of a system for an account schematic architecture, in accordance with embodiments.

System 100 includes a user electronic device 102 executing a schematic generation application 104 available through a user interface 135, a micro front-end (MFE) 106 comprising a network or computer including a processor executing one or more software modules and a memory for storing data accessible by the one or more software modules and instructions to execute the one or more software modules. The one or more software modules may include one or more of static user interface (UI) content service 108, data feed component 110, an event bus 112, data publish component 114, listeners/consumers 116, and databases 118. Databases 118 may include a solution database, an account database, a client database, a security database, and/or a research service. MFE 106 may send and receive information from datacenter 122. Listeners/consumers 116 and databases 118 may communicate, publish, and/or pull data from datacenter 122. Datacenter 122 may be a cloud-based or network database.

MFE 106 may be a set of software components working together and executed by a server and/or a computer. The server may be part of an institution backend. The server may be part of a cloud-based server. In some embodiments, the MFE 106 may reference one or more databases that are cloud-based or part of a network or computer to store information including executable instructions of MFE 106 and/or one or more software components.

In accordance with aspects, user electronic device 102 may be a user electronic device such as a personal communication device (e.g., tablet, phone), computer workstation, laptop, or other electronic processing device in operative communication with schematic generation application 104 and/or MFE 106. User electronic device 102 may be configured to interact with schematic generation application 104 through user interface 135. For instance, user device 102 may include a client application that allows a user of user electronic device 102 to interact with schematic generation application 104. User interface 135 may include one or more graphical user interfaces to receive inputs and/or display information to the user. User interface 135 and/or schematic generation application 104 may comprise one or more instructions executed by one or more processors of user electronic device 102. Schematic generation application 104 may be a software production application provided by a service organization. In an exemplary aspect, schematic generation application 104 may be an account schematic aggregation application or system.

In some embodiments, schematic generation application 104 may include an application programming interface (“API”) request (e.g., call) to communicate with MFE 106 to generate an account schematic and an account schematic architecture to manage the account schematic. In some embodiments, schematic generation application 104 may respond to an API call with updates to an account schematic such as to names, accounts, products, services, rates, and/or diagnostics. The schematics generation application 104 may check one or more databases for updates periodically or may do so and pull updated data based on an event (e.g., such as based on a user instruction or an updated account schematic data (e.g., names, accounts, products, services, rates, and/or diagnostics).

In some embodiments, static UI content service 108 may be a software program which may receive instructions for generating schematics from one or more databases such as a solution service, an account service, a client service, a security service, and/or a research service. Static UI content service 108 may further use real-time API calls. Static UI content service 108 may pull products from a product catalog, products on accounts from an elastic API, an opportunity from a sales database, a fraud protection service from a fraud reporting database, or a single source for multiple environment services and applications from an institution database. Static UI content service 108 may aggregate the data into one or more UI views in a schematic or grid view.

In some embodiments, static UI content service 108 may separate one or more accounts into subcategories based on one or more entity names, account subtype, currency, identifier, location, fraud risk rating, rate, account balance, frequency of use, and/or service name. In some embodiments, different types of accounts may be displayed. In some embodiments, priority of a number of generated account schematics may be determined based on frequency of use, level of difficulty, fiscal well-being, last client communication, and increased efficiency. In this way, account schematics with highest priority may be flagged by a user interface for a user/administrator.

In some embodiments, data feed component 110 may run based on a schedule. Data feed component 110 may connect to an API to retrieve a data file from a databank. The data feed component 110 may push/upload the data file to a cloud-based database or a network database. The cloud-based database or network database may generate a file-create event in response to the uploaded data file. The data feed component 110 may trigger an event bridge rule based on the data file being uploaded. In some embodiments, the data feed component 110 may invoke the data publish component 114 through an event bus 112 based on a data file create notification from data publish component 114. Data feed component 110 may pick up an individual data feed URL and any other parameters using an environment variables override. An environment variables override may occur by programmatically modify a setup configuration. A data feed url may be any source system through which data is received, wherein the url may be based any of the following communication protocols: http, ftp, sftp, and tcp. Data feed component 110 may update a record in a batch database as part of databases 118 to capture a batch status and a completion time.

In some embodiments, data publish component 114 may fetch the data file from the cloud-based database or the network database. The data publish component 114 may read the data file line by line and publish the messages of each line to a topic. The data publish component 114 may use a batch feature to publish multiple messages at a time to the topic. The data publish component 114 may set an attribute name and an attribute value so that the messages are routed to a correct queue. Attributes may be a feed name like a file name that include one or more of an account, a client, a user, a transaction, a billing, and a deposit. In some embodiments, the correct queue may use a filter policy to receive correct messages. The filter policy may be based on a threshold of keywords and/or one or more attributes.

Listeners/consumers 116 may, for each queue, have a listener (a task) that will initiate if it receives a message into each respective queue that the listener is listening to. The listener will read the messages and any inserts, updates, and/or deletes of the messages into the database.

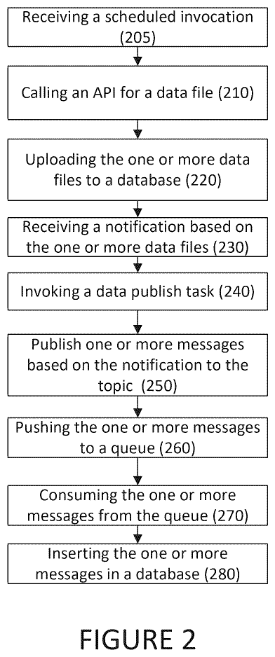

FIG. 2 is a method for an account schematic architecture, in accordance with some embodiments. The method may be stored as a list of instructions stored on a memory that when executed by one or more processors cause the one or more processors to perform the method.

Step 205 may include receiving, through an event bridge application executed by one or more processors, a scheduled invocation.

Step 210 may include calling, by a data feed task, an application programming interface (“API”) from a datacenter, the API call including a parameter used by the datacenter to retrieve one or more data files according to the parameter, the parameter including a name-value pair, the name-value pair including a name or identifier.

Step 220 may include receiving, by the data feed task, the one or more data files; uploading by the data feed task, the one or more data files to a cloud database or a network database or network file storage system.

Step 230 may include receiving, by the event bridge application and from the cloud database, a notification based on the one or more data files.

Step 240 may include invoking, by the event bridge application, a data publish task.

Step 250 may include publishing, by the data publish task, one or more messages based on an attribute name value pair of each parameter. A topic may be chosen for each attribute name value pair.

Step 260 may include pushing, by the data publish task, the one or more messages to a queue. The queue may be determined based on the topic.

Step 270 may include consuming, by a listener, the one or more messages from the queue based on detecting the queue receiving the one or more message.

Step 280 may include inserting, by the listener, the one or more messages in a database.

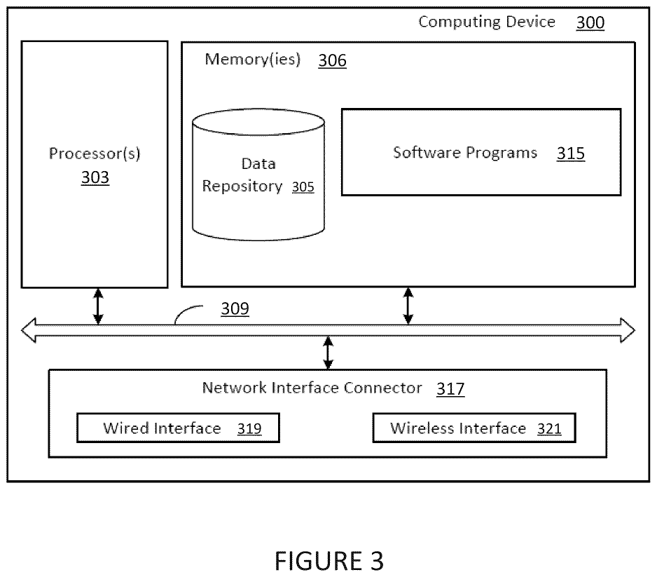

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, through an event bridge application executed by one or more processors, a scheduled invocation;
calling, by a data feed task executed by the one or more processors, an application programming interface (“API”) from a datacenter, the API call including a parameter used by the datacenter to retrieve one or more data files according to the parameter, the parameter including a name or identifier;
receiving, by the data feed task, the one or more data files; uploading by the data feed task, the one or more data files to a cloud database;
receiving, by the event bridge application and from the cloud database, a notification based on the one or more data files;
invoking, by the event bridge application, a data publish task executed by the one or more processors;
publishing, by the data publish task, one or more messages based on an attribute name value pair of each parameter to a topic;
pushing, by the data publish task, the one or more messages to a queue determined based on the topic;
consuming, by a listener executed by the one or more processors and configured to communicate with a database of a consumer device, the one or more messages from the queue based on detecting the queue receiving the one or more message; and
inserting, by the listener, the one or more messages in the database of the consumer device.

2. The method of claim 1, wherein the datacenter retrieves the parameter using an individual data feed URL using an environment variable override.

3. The method of claim 2, wherein the individual data feed URLis a source system based on a URL communication protocol.

4. The method of claim 1, wherein the queue includes a filter policy.

5. The method of claim 1, wherein the listener initiates when a message is received in the queue.

6. The method of claim 1, wherein the listener initiates when an insert, update, or deletion of the message in the queue.

7. The method of claim 1, wherein the data publish task uses a batch feature to publish multiple messages of the one more messages at a time to the topic.

8. A computer processing system comprising:
a memory configured to store instructions; and
a hardware processor operatively coupled to the memory for executing the instructions of a text or call processing program to:
receiving, through an event bridge application executed by the hardware processor, a scheduled invocation;
calling, by a data feed task executed by the one or more processors, an application programming interface (“API”) from a datacenter, the API call including a parameter used by the datacenter to retrieve one or more data files according to the parameter, the parameter including a name or identifier;
receiving, by the data feed task, the one or more data files; uploading by the data feed task, the one or more data files to a cloud database;
receiving, by the event bridge application and from the cloud database, a notification based on the one or more data files;
invoking, by the event bridge application, a data publish task executed by the hardware processor;
publishing, by the data publish task, one or more messages based on an attribute name value pair of each parameter to a topic;
pushing, by the data publish task, the one or more messages to a queue determined based on the topic;
consuming, by a listener executed by the hardware processor and configured to communicate with a database of a consumer device, the one or more messages from the queue based on detecting the queue receiving the one or more message; and
inserting, by the listener, the one or more messages in the database of the consumer device.

9. The system of claim 8, wherein the datacenter retrieves the parameter using an individual data feed URL using an environment variable override.

10. The system of claim 9, wherein the individual data feed URLis a source system based on a URL communication protocol.

11. The system of claim 8, wherein the queue includes a filter policy.

12. The system of claim 8, wherein the listener initiates when a message is received in the queue.

13. The system of claim 8, wherein the listener initiates when an insert, update, or deletion of the message in the queue.

14. The system of claim 8, wherein the data publish task uses a batch feature to publish multiple messages of the one more messages at a time to the topic.

15. A non-transitory computer readable storage medium, including instructions stored thereon, which when read and executed by one or more computer processors, cause the one or more computer processors to perform steps comprising:
receiving, through an event bridge application executed by one or more processors, a scheduled invocation;
calling, by a data feed task executed by the one or more processors, an application programming interface (“API”) from a datacenter, the API call including a parameter used by the datacenter to retrieve one or more data files according to the parameter, the parameter including a name or identifier;
receiving, by the data feed task, the one or more data files; uploading by the data feed task, the one or more data files to a cloud database;
receiving, by the event bridge application and from the cloud database, a notification based on the one or more data files;
invoking, by the event bridge application, a data publish task executed by the one or more processors;
publishing, by the data publish task, one or more messages based on an attribute name value pair of each parameter to a topic;
pushing, by the data publish task, the one or more messages to a queue determined based on the topic;
consuming, by a listener executed by the one or more processors and configured to communicate with a database of a consumer device, the one or more messages from the queue based on detecting the queue receiving the one or more message; and
inserting, by the listener, the one or more messages in the database of the consumer device.

16. The non-transitory computer readable storage medium of claim 15, wherein the datacenter retrieves the parameter using an individual data feed URL using an environment variable override.

17. The non-transitory computer readable storage medium of claim 16, wherein the individual data feed URLis a source system based on a URL communication protocol.

18. The non-transitory computer readable storage medium of claim 15, wherein the queue includes a filter policy.

19. The non-transitory computer readable storage medium of claim 15, wherein the listener initiates when a message is received in the queue.

20. The non-transitory computer readable storage medium of claim 15, wherein the listener initiates when an insert, update, or deletion of the message in the queue.
